(19) United States
(12) Patent Application Publication
(10) Pub. No.: US 2024/0150118 A1
(43) Pub. Date: May 9, 2024

(54) Mechanical Door for Warehouse Shuttle

(71) Applicant: Cleveron AS, Viljandi (EE)

(72) Inventor: Tarmo Must, Viljandi (EE)

(21) Appl. No.: 18/502,562

(22) Filed: Nov. 6, 2023

Related U.S. Application Data
(60) Provisional application No. 63/382,613, filed on Nov. 7, 2022.

(51) Int. Cl. B65G 1/04; E06B 3/46; E06B 3/70; F25D 23/02; F25D 25/04

(52) U.S. Cl. CPC B65G 1/0492; E06B 3/4636; E06B 3/7015; F25D 23/021; F25D 25/04

(57) ABSTRACT

The invention provides a mechanical solution as to how a shuttle device may move between different temperature zones in an automated warehouse and still maintain the temperature in each temperature zone. A mechanical solution is provided to operate the doors separating the temperature zones. The doors are designed to close access openings between two modules and the openings are of such size that the shuttle can move through the opening. The doors are equipped with wheels and they are capable of moving along the same rails as the warehouse shuttle. The shuttle thus can push the door in front of it while exiting one module and entering another module. The shuttle can pull the door back to its place and thus close the opening between the modules when returning back to the first module.

### FIELD OF THE INVENTION

This invention is related to automated warehouses using a shuttle system to retrieve and load items from and to the warehouse. More specifically the invention is related to access systems between different modules in the warehouse and specifically between different temperature zones in the warehouse.

### BACKGROUND

In ever increasing need of solutions to effective fulfilment systems for merchandise, especially critical and needed are solutions for warehouses to store groceries that require different temperature zones in the warehouse.

In a limited space where automated warehouses are typically used there is a need to have multiple temperature zones for storing frozen and chilled goods. There are disclosures that solve the problem of delivery to multiple temperature zones by providing automatic warehouse systems designed so that articles are moved from the loading area only to one selected temperature zone without a need of the shuttle to operate via multiple temperature zones.

An example of such solution is Canadian patent 3166646. WO2021243059A1 discloses a storage system that may have multiple temperature zones, but in this disclosure each temperature zone has an independent robotic vehicle operating in a single temperature zone. US20170029210 describes a storage system with multiple temperature zones where the different temperature zones are separated by insulated movable partition walls and an automated inserter/extractor is capable of moving from a temperature zone to another through the movable partitions that are hinged, sliding or roller doors controlled electronically or pneumatically.

Thus, even if there are some solutions as to how a shuttle device may move between different temperature zones in an automated warehouse there is still a need to solve a problem as to how should the access of the shuttle device be provided such as to minimize the energy loss when the shuttle moves from one temperature zone to another, and how to maintain the temperature in each temperature zone with minimum energy consumption.

The existing solutions either provide systems where a shuttle is not required to move through multiple temperature zones, or alternatively there is a motorized door system between the temperature zones.

### SUMMARY

This invention provides solutions to the above-mentioned problems and more. A solution is disclosed here where mechanically openable/closable access openings allow a shuttle device to move from one warehouse module to another. There is an access opening in each support level of the warehouse, and the access opening is dimensioned such that it allows the shuttle to move through it. Contrary to various existing solutions, the system disclosed here does not include a large door between the modules. The invention according to this disclosure is especially beneficial where the shuttle device is moving between two storage modules having different temperatures zone.

An object of this invention is to provide a simple and economic access system for shuttle device of an automated warehouse moving between different temperature zones.

More specifically, an object of the invention is to provide an automated warehouse storage system, which comprises a multitude of modules; each module comprises at least two parallel racks, and an aisle in between the racks; each of the at least two parallel racks comprise one or more support levels configured to hold a multitude of crates; each of the one or more support levels comprise a rail element protruding horizontally toward the aisle and extending in a direction of the aisle between the multitude of modules; the warehouse comprises at least one shuttle device configured to retrieve and deliver crates from and to the racks and moving horizontally along the aisle between the multitude of modules, and the shuttle is supported by the rail elements of two support levels located on opposite sides of the aisle; in the warehouse at least two horizontally adjacent modules having different temperatures are separated from each other by a panel comprising a multitude of access openings through which the rail elements extend; each access opening is located such that the at least one shuttle device fits through the access opening when moving along the rail elements between the two horizontally adjacent modules; and each access opening is openable and closable by a door plate comprising a pair of drive wheels enabling the door plate to move along the rail elements when pushed or pulled by the at least one shuttle, and the access opening is opened when the at least one shuttle device moves from a first of the horizontally adjacent modules to a second of the horizontally adjacent modules and pushing the door plate off the access opening, and closed when the at least one shuttle device upon returning from the second horizontally adjacent module to the first horizontally adjacent module pulls the door plate back to the access opening.

In certain aspects of the invention the panel in the automated warehouse storage system is an insulated panel. The door plates in the automated warehouse may also comprise insulated material.

The door plates may have a steel plate configured to magnetically attach to the shuttle device when the shuttle device pushes against the door plate when moving through the two horizontally adjacent modules. The door plates may additionally comprise support rollers, and/or spring-loaded rollers. The door plates may also comprise sealing elements at least partially around a perimeter of the door plates.

According to certain aspects of the invention in the automated warehouse storage system, at least one of the horizontally adjacent modules is temperature controlled to maintain a freezing or a chilling temperature. Preferably, a module at one end of the automated warehouse storage system is temperature controlled to maintain freezing or chilling temperature.

It is a further object of this invention to provide an access system between a first and a second horizontally adjacent modules of an automated warehouse system having at least one shuttle device moving between the first and the second horizontally adjacent modules separated by a panel; the access system comprises at least one access opening and at least one door plate, wherein the at least one access opening is dimensioned such that the at least one shuttle device can enter through the access opening; and the at least one access opening is opened when the at least one shuttle device attaches to the door plate upon a contact when pushing against the door plate when moving from the first horizontally adjacent module to the second horizontally adjacent module, and the at least one access opening is closed when the at least one shuttle device returns from the second horizontally adjacent module to the first horizontally adjacent module and pulls the door plate back to the access opening.

The door plates of the access system comprise drive wheels configured to allow the door plates to move along the rails extending from the first horizontally adjacent module to the horizontally adjacent second module. The door plates of the access system may comprise insulating materials. The door plates of the access system comprise sealing elements around at least a part of the perimeter of the door plates.

According to certain aspects of the invention in the access system, the door plate has an attachment area configured to attach to the shuttle device with a magnet upon contact when the shuttle device pushes against the door plate when moving from the first horizontally adjacent module to the second horizontally adjacent module. The attachment area may be a steel plate.

The panel in the access system is preferably an insulated panel. The panel is configured to separate two horizontally adjacent modules where temperature in the modules is controlled to be different. Preferably, one of the adjacent modules is temperature controlled to maintain a freezing or chilling temperature.

It is an object of the invention to provide an insulated storage module comprising at least two parallel racks, and an aisle in between the racks, each of the at least two parallel racks comprising one or more support levels configured to hold a multitude of crates; the insulated module further comprises an access system for an entry of a shuttle device, and the access system comprises at least one access opening and at least one door plate, wherein the at least one access opening is dimensioned such that the at least one shuttle device can enter through the access opening; and the at least one access opening is opened when the at least one shuttle device attaches to the door plate upon a contact when pushing against the door plate when entering the insulated module, and the at least one access opening is closed when the at least one shuttle device exits the insulated module through the same access opening and pulls the door plate back to the access opening.

The door plates in the insulated storage module comprises sealing elements around at least part of a perimeter of the door plates. The door plates comprise insulating material.

The insulated storage module the insulted module is configured to be attached to an automated warehouse comprising a multitude of insulated or non-insulated modules. The insulated storage module is preferably temperature controlled to maintain freezing or chilling temperatures.

### BRIEF DESCRIPTION OF THE DRAWINGS

FIG. 1 shows a module (1) comprising two racks (2) and an aisle (3) between them. Racks are divided into support levels (4), each support level can carry a multitude of crates (5). The figure also shows rail elements (6) that are attached to the support levels and protrude toward the aisle.

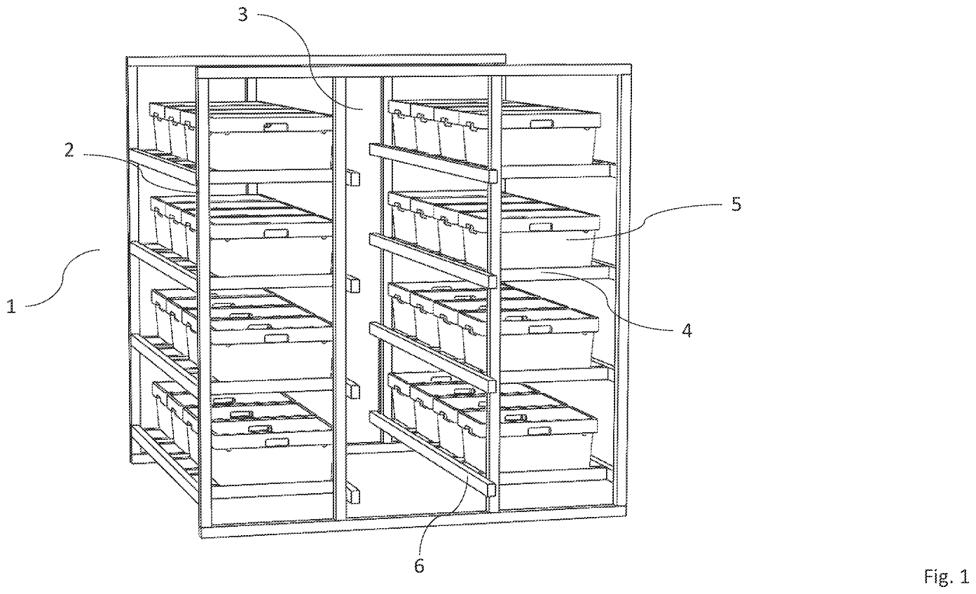

FIG. 2 shows a multitude of modules (1) connected to each other; in this illustration there are three modules lengthwise and two modules on top of each other, but any suitable number of modules can be chosen to be connected. Also shown in the figure is one insulated module (11) to create a different temperature zone.

FIG. 3 shows a cut-out view of two horizontally adjacent modules (1) of which one is a freezer module (21). A shuttle device (22) is shown on the rail elements (6) at the lowermost support level of one of the modules and another shuttle device (26) is shown at the uppermost support level in the freezer section (21), pushing a door plate (24) in front of it and thereby leaving an open access opening (25) between the modules. Also shown are insulated panels (23) in between the modules and mechanical door plates (24) closing access openings

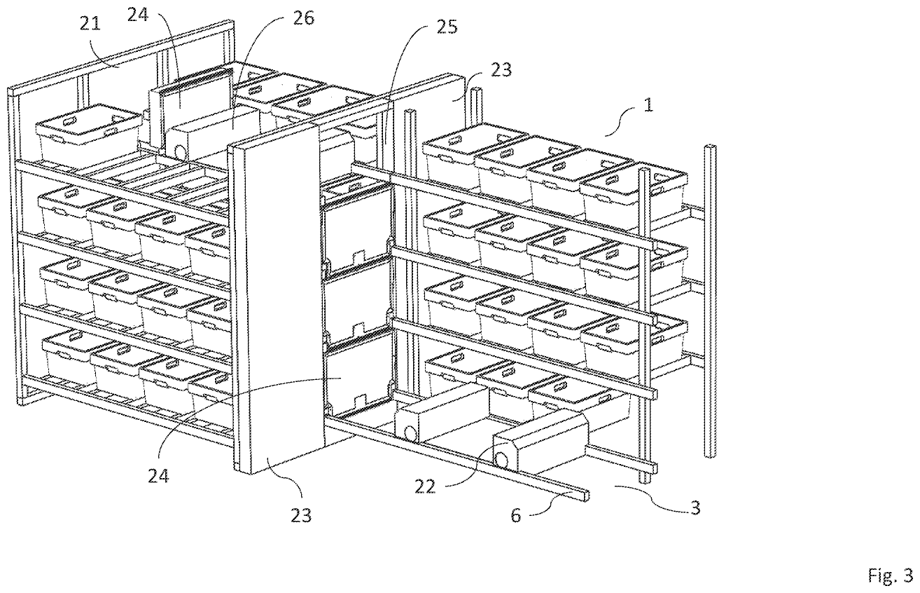

FIG. 4 shows the door plate (24) viewed from two directions. In this detailed view drive wheels (30) and support rollers (31) are also visible as is one spring loaded roller (32). These rollers are mounted on the roller brackets (33). The door plate's main structure, an insulation panel (34) and brush seals (35) around part of the perimeter are also visible as is the magnet attachment area (36).

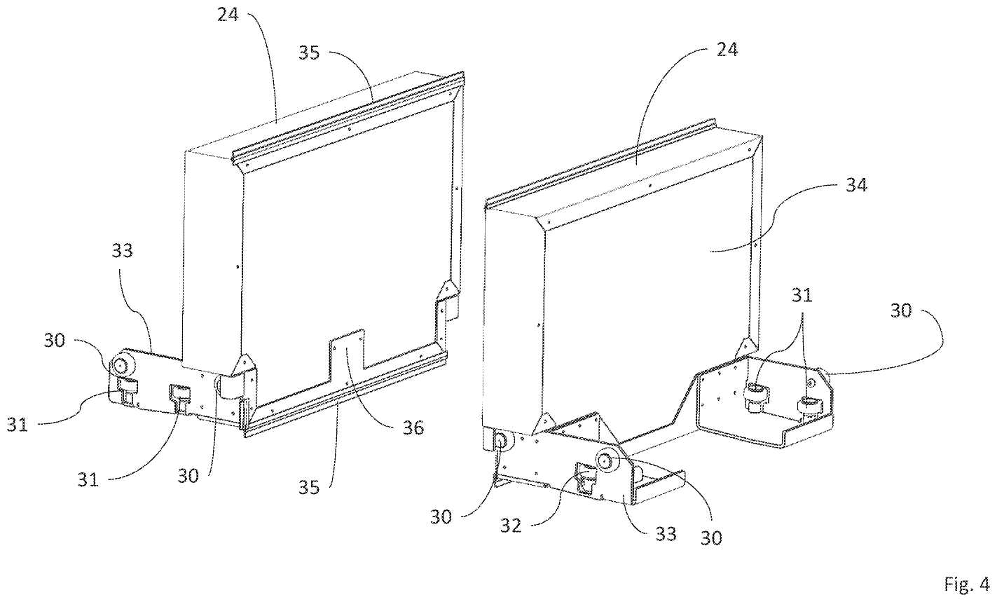

FIG. 5 depicts a moment where the shuttle device (22) has pushed the door plate (24) into the freezer area (a module with temperature controlled to be freezing temperature) to retrieve a crate (5). Here the access opening (25) through which the shuttle device entered remains open until the shuttle device pulls back through the access opening and brings the door plate back after it has loaded the crate.

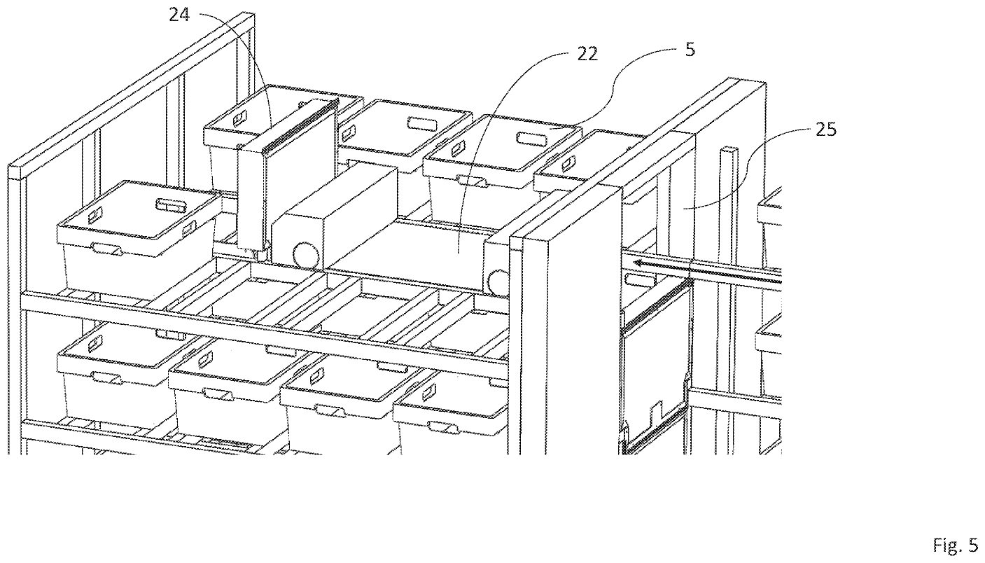

FIG. 6 depicts a moment where the shuttle device (22) has loaded a crate (5) onto itself and is ready to move out of the freezer section through the access opening (25) pulling the door plate (24) behind itself so as to close the access opening (25).

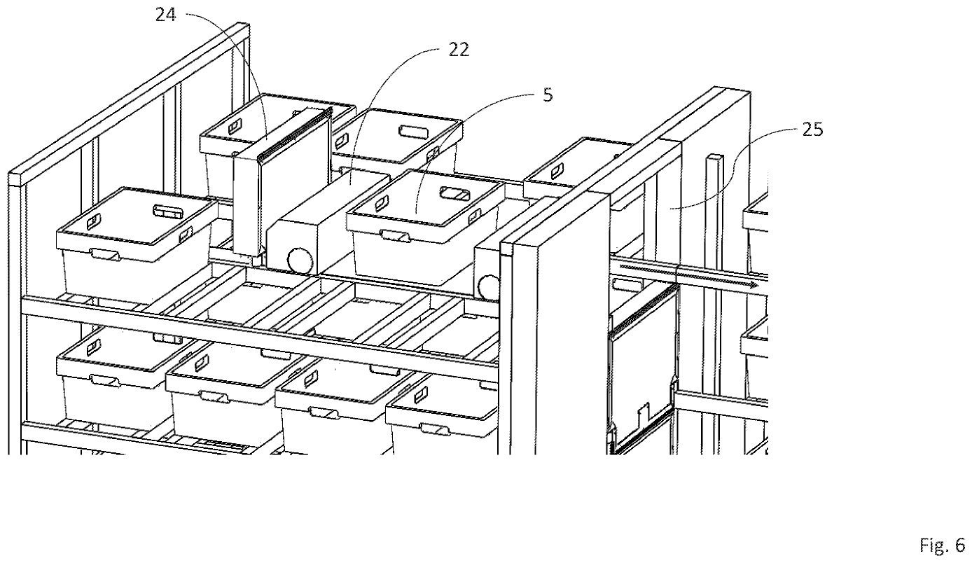

### DETAILED DESCRIPTION OF THE INVENTION

The invention provides mechanically movable doors placed on the aisles that move on the same rails as the shuttle devices and are configured to be pushed into a module having different temperature (e.g. to a freezer section) by the shuttle device, whereby an access opening is opened and will get closed when the shuttle device pulls the door plate back when returning through the same access opening after it has loaded or unloaded the crate to the rack. The solution is completely mechanical and no need to electronic or pneumatic operations is needed. Moreover, the invention provides a solution where the opening through which the shuttle device is moving is smallest possible so as to prevent any additional energy losses. There is no need of a door that opens for any more than for what is needed for the dimensions of the shuttle device. The automated storage system according to the invention comprises a multiple storage modules each comprising a rack with multiple support levels of shelves defining item storage positions, an aisle at each support level, rail elements attached to each support level protruding toward the aisle to allow moving of shuttle device along the rail elements for delivering and retrieving items to and from the storage positions on each support level. The modules can be joined together horizontally or vertically. The rails attached to the support levels extend through horizontally adjacent modules so that the shuttle device can travel through multiple horizontally adjacent modules. Any number of the modules may have a temperature control to maintain certain temperatures. Especially modules that are controlled to maintain temperatures different from ambient temperatures are insulated. Preferably the insulated modules are located at the ends of the warehouse system such that they are connected only to one other horizontally adjacent module.

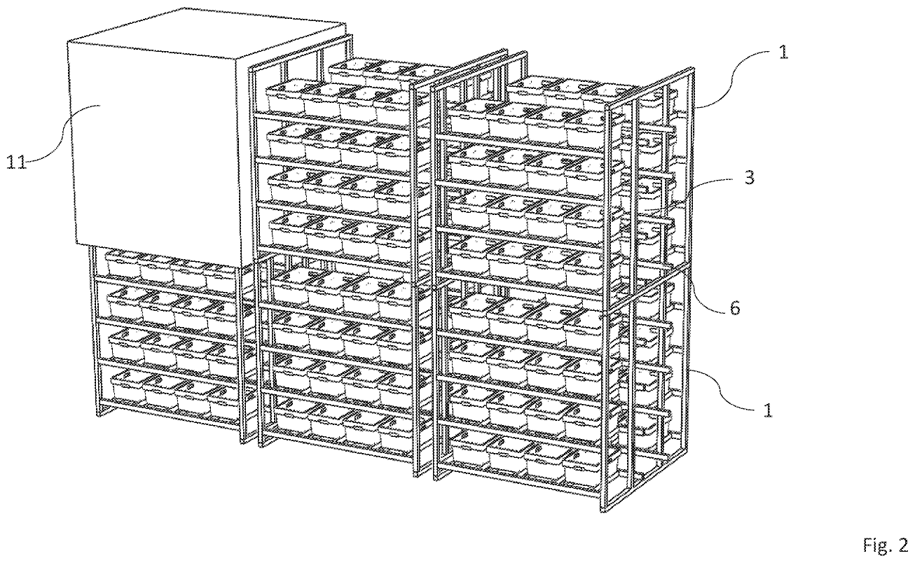

The automated warehouse of this disclosure is designed to have multiple temperatures for example for storing grocery items requiring different storage temperatures. Because the need for different temperatures is varying, it would not be efficient to have for example all support levels of each horizontally adjacent module programmed to same temperature. Such configuration most likely would provide too little space for items to be stored at certain temperature while providing too much space for items to be stored in another temperature. To solve this problem the disclosure here provides an automated warehouse system where one module may be programmed to be maintained in different temperature than the adjacent modules. FIG. 2 illustrates a situation where upper module of one of the six modules is thermally isolated. The disclosure here provides a simple, efficient, economic and completely mechanic solution to open and close an access opening to allow the shuttle device to move along the horizontally extending rails from a module having a different temperature to the insulated module.

The access system for the shuttle device to move from one temperature zone (i.e. one module) to another comprises mechanically movable door plates that are placed in access openings formed in a panel separating the modules. The panel may be of insulating material or may comprise insulating material. The rail elements are extending horizontally through the access openings between horizontally adjacent modules such that the shuttle device can move from a module to another. The door plates may comprise or may be of insulated material. The door plates preferably have a metallic attachment area (a steel plate) for a magnet attachment for the shuttle device to attach to when it pushes against the door plate. The door plate has driving wheels and/or rollers in its lower part such that when the shuttle device pushes the door plate off from the access opening, the door plate attached now to the shuttle device can move along the same rail elements as the shuttle device while pushed by the shuttle device. The shuttle device which comprises a loading system is computer controlled to stop at a location where it loads or unloads a crate from a support level of a rack and once the crate has been loaded or unloaded the shuttle device returns through the same access opening it entered, and now the shuttle device pulls the door plate back to access opening to close the access opening. The access opening may have physical stops to prevent the door plate to be pulled through the access opening. The door plate may have brush, or rubber seals along at least part of its perimeter to seal the door plate properly to the access opening. Alternatively, or additionally the door plate may have magnetic attachment areas on its perimeter to attach it to the access opening.

In a preferred embodiment automated warehouse comprises a multitude of modules joint to each other horizontally and/or vertically to construct a warehouse having dimensions suitable for the space available. Preferably, the module at one end of the warehouse may be insulated to convert it into a different temperature zone. It is possible also to have insulated modules at both ends of the warehouse. One likely option is to convert the end module(s) to freezer sections. A freezer section may comprise one full module, or it may have a size of multiple modules. The freezer section may be insulated by having the walls, ceiling, and bottom insulated with standard insulating materials such as sandwich panels. The horizontally adjacent modules of different temperatures are separated by a panel which may also be standard insulating material. The rail elements (and the aisle) extend horizontally through a module to another, and the shuttle device is configured to move along the rail elements from one module to another. In order to be able to move from modules of different temperatures, the shuttle device has to be able to move through the panel separating the modules. This disclosure provides a novel solution to open and close an access opening in the panel when the shuttle is moving on the aisle along the rail elements from a module to another. The shuttle device pushes a door plate off from the access opening when entering the freezer section. The door plates may be mainly made of the same insulation sandwich panel that is used for the module insulation. To help to stabilize the potentially light door plate and bring the centre of gravity as low as possible the lower parts of the door plate may have extra weights added to them, or they may be made from thicker steel materials.

The door plates have drive wheels that allow them to move on the same rails as the shuttle device. The drive wheels are also configured to support the door plates vertically. Each door plate has a multitude of drive rollers contacting the rail element from top side of the rail. To limit the sideways movement of door plates and to prevent the door plate from contacting the rail elements from the side, the door plates also have side support rollers. Each side of the door plate may have a multitude of spring-loaded support rollers or fixed idler rollers to keep the door plate centred in the aisle and not in contact with the rail elements. These support rollers are in contact with the rail elements from the side. To mount these rollers to the door plates, the plates may further have brackets on their lower parts. To limit the number of rollers the door plate may have an uneven number of rollers on each of its sides. Also, to help to stabilize the door plate while it is being moved by the shuttle device along the rails elements and keep it running on the rail elements without any rollers supporting it from the bottom of the rail element, some of the side support rollers are slightly angled in their vertical axis.

Freezer section door plates preferably have brush seals around at least part of their perimeter to close off any gap that remains when the door plate is closing the access openings. Some of these brush seals may be mounted also on the sides of the access openings. Instead of brushes also rubber seals of different profilers may be used. In another embodiment magnetic seals may be used around at least part of the perimeter of the door plate.

When the shuttle device needs to move into the freezer section (or generally to a section having a different temperature) to deposit or retrieve a crate it will come in contact with the door plate. The shuttle device may have buffers to help the contact being made to be smoother. While in contact with the door plate also a magnet may be engaged by the shuttle device to the door plate so that the door plate can be either pulled or pushed by the shuttle device. This magnet can be either a permanent magnet or an electromagnet. To help the magnet stick to the door plate the door plate may have a steel plate for magnet attachment. Other attachment means may also be used.

While the shuttle device is in contact with the door plate, it pushes the door plate into the freezer section. After the shuttle device has loaded or unloaded its crate into or from the freezer section (or generally into the section having different temperature) it returns through the same access opening it entered and exits the freezer section and pulls the door plate behind it. When the door plate enters the opening access to close it, the shuttle may slow down to allow the door plate to come in contact with physical stops that prevent it moving further with the shuttle. At the same time the magnet would be disengaged, and the shuttle would move along the rail element on the aisle without the door plate.

While the shuttle is in the freezer section the access opening is open and therefore one part of the freezer section insulation is absent. To alleviate this, an air curtain is used in front of the door plates. The air curtain may also be used when all the door plates are in a closed position to minimize the amount of cold air leaking between the door plates and access openings.

### LIST OF ELEMENT NUMBERS

1 Module
2 Rack
3 Aisle
4 Support level
5 Crate
6 Rail element
11 Insulated module
21 Freezer section
22 Shuttle device
23 Panels
24 Door plate
25 Access opening
30 Drive wheels
31 Support rollers
32 Spring loaded roller
33 Roller bracket
34 Door plate of insulated material
35 Brush seals
36 Magnet attachment area (steel plate)

1. An automated warehouse storage system, comprising a multitude of modules;
each module comprising at least two parallel racks, and an aisle in between the at least two parallel racks, each of the at least two parallel racks comprising one or more support levels configured to hold a multitude of crates;
each of the one or more support levels comprising a rail element protruding horizontally toward the aisle and extending horizontally through the multitude of modules; and
at least one shuttle device configured to retrieve and deliver crates from and to the one or more support levels and moving horizontally along the aisle between the multitude of modules, and being supported by the rail elements of two support levels located on opposite sides of the aisle;
wherein at least two horizontally adjacent modules having different temperatures and being separated from each other by a panel comprising a multitude of access openings through which the rail elements extend,
each access opening located such that the at least one shuttle device fits through the access opening when moving along the rail elements between the two horizontally adjacent modules; and
wherein each access opening is openable and closable by a door plate comprising a pair of drive wheels enabling the door plate to move along the rail elements when pushed or pulled by the at least one shuttle, and
wherein the access opening is opened when the at least one shuttle device moves from a first of the horizontally adjacent modules to a second of the horizontally adjacent modules pushing the door plate off the access opening and closed when the at least one shuttle device upon returning from the second horizontally adjacent module to the first horizontally adjacent module pulls the door plate back to the access opening.

2. The automated warehouse storage system of claim 1, wherein the panel is an insulated panel.

3. The automated warehouse storage system of claim 1, wherein the door plate comprises insulating material.

4. The automated warehouse storage system of claim 1, wherein the door plate has a magnetic attachment area configured to attach to the shuttle device when the shuttle device pushes against the door plate when moving from the first horizontally adjacent module to the second horizontally adjacent module.

5. The automated warehouse storage system of claim 1, wherein at least one of the horizontally adjacent modules is temperature controlled to maintain a freezing or chilling temperature.

6. The automated warehouse storage system of claim 1, wherein the door plate additionally comprises support rollers, and/or spring-loaded rollers.

7. The automated warehouse storage system of claim 1, wherein the door plate comprises sealing elements at least partially around a perimeter of the door plate.

8. An access system between a first and a second horizontally adjacent modules of an automated warehouse system having at least one shuttle device configured to move along rails between the first and the second horizontally adjacent modules separated by a panel;
the access system comprising at least one access opening and at least one door plate, wherein the at least one access opening is dimensioned to allow the at least one shuttle device to move through the at least access opening; and
the at least one access opening is opened when the at least one shuttle device attaches to the at least one door plate upon a contact when pushing against the at least one door plate while moving from the first horizontally adjacent module to the second horizontally adjacent module, and
the at least one access opening is closed when the at least one shuttle device returns from the second horizontally adjacent module to the first horizontally adjacent module and pulls the door plate back to the at least one access opening.

9. The access system according to claim 8, wherein the at least one door plate comprises drive wheels configured to allow the at least one door plate to move along the rails extending from the first horizontally adjacent module to the second horizontally adjacent module.

10. The access system according to claim 8, wherein the at least one door plate has a metal plate for magnetic attachment configured to attach to the at least one shuttle device upon contact when the at least one shuttle device pushes against the at least one door plate when moving through the at least one access opening from the first horizontally adjacent module to the second horizontally adjacent module.

11. The access system of claim 8, wherein the at least one door plate is of insulating material.

12. The access system according to claim 8, wherein the at least one door plate comprises sealing elements around at least a part of a perimeter of the at least one door plate.

13. The access system of claim 8, wherein the horizontally adjacent modules have different temperatures.

14. The access system of claim 8, wherein the panel is an insulated panel.

15. The access system of claim 13, wherein at least one of the horizontally adjacent modules is temperature controlled to maintain a freezing or a chilling temperature.

16. An insulated storage module comprising at least two parallel racks, and an aisle in between the racks, each of the at least two parallel racks comprising one or more support levels configured to hold a multitude of crates;
the module further comprising an access system for an entry of a shuttle device, the access system comprising at least one access opening and at least one door plate, wherein the at least one access opening is dimensioned such that the at least one shuttle device can enter through the access opening: and
the at least one access opening is configured to open when the at least one shuttle device attaches to the at least one door plate upon a contact and pushes against the at least one door plate and the at least one access opening is configured to close when the at least one shuttle device pulls the at least one door plate back to the access opening.

17. The insulated storage module of claim 16, wherein the at least one door plate comprises sealing elements around at least part of a perimeter of the at least one door plate.

18. The insulated storage module of claim 16, wherein the at least one door plate is of insulating material.

19. The insulated storage module of claim 16, wherein the module is temperature controlled to maintain a freezing or chilling temperature.

20. The insulated storage module of claim 16, wherein the access system is configured to provide access to an adjacent storage module in an automated warehouse comprising multitude of storage modules.
